(19) United States
(12) Patent Application Publication
(10) Pub. No.: US 2026/0169564 A1
(43) Pub. Date: Jun. 18, 2026

(54) SOUND-FOLLOWING VIBRATION CONTROL METHOD, SYSTEM, ELECTRONIC DEVICE, AND STORAGE MEDIUM

(71) Applicant: AAC Acoustic Technologies (Shanghai) Co., Ltd., Shanghai (CN)

(72) Inventors: Shiyu Pei, Shanghai (CN); Yajun Zheng, Shanghai (CN)

(21) Appl. No.: 19/328,111

(22) Filed: Sep. 13, 2025

Related U.S. Application Data
(63) Continuation of application No. PCT/CN2024/139163, filed on Dec. 13, 2024.

(51) Int. Cl. G06F 3/01; G10L 25/24

(52) U.S. Cl. CPC G06F 3/016; G10L 25/24

(57) ABSTRACT

Provided are a sound-following vibration control method, system, electronic device, and storage medium. The method includes: extracting a psychological loudness feature of target audio data, where the psychological loudness feature includes a loudness value, an instantaneous power peak, a central frequency, and a moment of a single-frame audio data; calculating intensity information using the loudness value and the instantaneous power peak, and mapping the central frequency to a central Mel frequency; obtaining a relative frequency curve according to the central Mel frequency of all single-frame audio data, and obtaining a relative intensity curve according to the intensity information of all single-frame audio data; generating a sound-following vibration signal according to the relative frequency curve and the relative intensity curve; and sending the sound-following vibration signal to output vibration feedback. This method is simple and efficient, thereby balancing the designer workload and effectively improving the vibration feedback experience.

### CROSS-REFERENCE TO RELATED APPLICATIONS

This application is a continuation of International Application No. PCT/CN2024/139163, filed on Dec. 13, 2024, the entire contents of which are incorporated herein by reference.

### TECHNICAL FIELD

The present application relates to the field of haptic feedback technologies, in particular to a sound-following vibration control method, system, electronic device, and storage medium.

### BACKGROUND

With the advancement of technology, the application of vibration feedback is no longer limited to simple vibration notifications. Common electronic devices such as smartphones, tablets, and even handles as the most frequent carriers for video and gaming content, are increasingly incorporating vibration feedback alongside audio and video, so as to provide users with a more diverse sensory experience. However, high-quality vibration feedback currently relies on vibration designers to manually create effects that match the context of the content. As the demand for vibration feedback in audio and video continues to grow, the workload for vibration designers is also increasing.

Furthermore, according to relevant psychological studies, human subjective auditory perception is not linear. The loudness values of audio data generally cannot directly map to people's subjective auditory experiences. As a result, the vibration feedback mechanisms provided by the related art struggle to ensure consistency between auditory and tactile sensations, leading to subpar vibration feedback experiences. This makes it difficult to deliver an immersive sensory experience for users.

Therefore, it is necessary to provide an automatically generated vibration control method with sound effects to balance the workload of the relevant designers, and effectively improve the human body's experience of the sound vibration feedback mechanism.

### SUMMARY

An object of the present application is to provide a sound-following vibration control method, apparatus, electronic device, and storage medium, which can at least solve the problems of the heavy workload of designers of sound effects vibration and poor experience effect of the human body on the feedback mechanism of sound effects vibration in the related art.

In order to solve the above technical problems, a first aspect of the embodiments of the present application provides a sound-following vibration control method, including:
extracting a psychological loudness feature of target audio data, wherein the psychological loudness feature includes a loudness value, an instantaneous power peak, a central frequency, and a moment of a single-frame audio data;
calculating intensity information using the loudness value and the instantaneous power peak, and mapping the central frequency to a central Mel frequency;
obtaining a relative frequency curve according to the central Mel frequency of all single-frame audio data, and obtaining a relative intensity curve according to the intensity information of all single-frame audio data;
generating a sound-following vibration signal according to the relative frequency curve and the relative intensity curve; and
sending the sound-following vibration signal to an actuator to drive the actuator to output a corresponding vibration feedback.

A second aspect of embodiments of the present application provides a sound-following vibration control apparatus, including:
a feature extracting module configured to extract a psychological loudness feature of target audio data, wherein the psychological loudness feature includes a loudness value, an instantaneous power peak, a central frequency, and a moment of a single-frame audio data;
a feature mapping module configured to calculate intensity information using the loudness value and the instantaneous power peak, and mapping the central frequency to a central Mel frequency;
a parameter determination module configured to obtain a relative frequency curve according to the central Mel frequency of all single-frame audio data, and obtain a relative intensity curve according to the intensity information of all single-frame audio data;
a signal generating module configured to generate a sound-following vibration signal according to the relative frequency curve and the relative intensity curve; and
a driving module configured to send the sound-following vibration signal to an actuator to drive the actuator to output a corresponding vibration feedback.

A third aspect of the present application provides an electronic device including: a memory and a processor configured to execute a computer program stored in the memory; wherein the processor, when executing the computer program, realizes the steps in the sound-following vibration control method described in the above-described first aspect of embodiments of the present application.

A fourth aspect of the present application provides a computer-readable storage medium having a computer program stored thereon, wherein the computer program, when executed by the processor, realizes the steps in the sound-following vibration control method described in the above-described first aspect of embodiments of the present application.

As can be seen from the foregoing description, compared to the related art, the beneficial effects of the present application are as follows:

Firstly, a psychological loudness feature is extracted from the target audio data and intensity information is calculated using the loudness values and the instantaneous power peaks in the psychological loudness feature, and the central frequency is mapped to a central Mel frequency. Secondly, a relative frequency curve is obtained according to the central Mel frequency of all single-frame audio data, and a relative intensity curve is obtained according to the intensity information of all single-frame audio data. Finally, a sound-following vibration signal is generated according to the relative frequency curve and the relative intensity curve, and the sound-following vibration signal is sent to an actuator to drive the actuator to output a corresponding vibration feedback. As can be seen from the above, in the embodiments of the present application, psychological loudness characteristics are extracted from audio data, and loudness values, center frequencies, and power peaks are transformed into the relative intensity curve and relative frequency curve using psychological evaluation indexes combined with Mel weighting. A sound-following vibration signal is generated according to the relative intensity curve and relative frequency curve to maximize the retention of effective information mapped to actuator vibration parameters, and complete the vibration feedback control with sound effects, thereby effectively improving the richness of the human body's perception of vibration feedback, and bringing users an immersive sensory experience. In addition, this method enables the automatic generation of vibration feedback in a simple and efficient manner. On one hand, it meets the need for content providers to perform independent batch conversions. On the other hand, it requires only minimal optimization by designers to achieve high-quality vibration feedback, thereby further balancing the workload of design personnel.

It should be understood that the contents described in this part are not intended to identify key or important features of the present application, nor are they intended to limit the scope of the present application. Other features of the present application will be readily understood through the following specification.

### BRIEF DESCRIPTION OF THE DRAWINGS

In order to more clearly illustrate the technical solutions in the embodiments of the present application, the accompanying drawings to be used in the description of the embodiments will be briefly introduced below. Obviously, the accompanying drawings in the following description are only some embodiments of the present application, and for the person of ordinary skill in the field, other accompanying drawings may be obtained according to these drawings without putting in creative labor.

FIG. 1 shows a flowchart of a sound-following vibration control method according to an embodiment of the present application.

FIG. 2 shows a refined flowchart of the sound-following vibration control method according to an embodiment of the present application.

FIG. 3 shows a schematic diagram of a vibration signal generated according to an original sound effect according to an embodiment of the present application.

FIG. 4 shows a schematic diagram of a program module of a sound-following vibration control apparatus according to an embodiment of the present application.

FIG. 5 is a block diagram of modules of an electronic device according to an embodiment of the present application.

FIG. 6 shows a block diagram of modules of a computer-readable storage medium according to an embodiment of the present application.

### DETAILED DESCRIPTION OF THE EMBODIMENTS

In order to make the objects, technical solutions, and advantages of the present application more obvious and understandable, the present application will be described clearly and completely in the following in connection with the embodiments of the present application and the accompanying drawings thereof, where the same or similar symbols throughout denote the same or similar elements or elements having the same or similar functions. It should be understood that the various embodiments of the present application described herein below are only for explaining the present application and are not intended to limit the present application. That is, according to the various embodiments of the present application, all other embodiments obtained by a person of ordinary skill in the art without making creative labor fall within the scope of protection of the present application. Furthermore, the technical features involved in the various embodiments of the present application described below may be combined with each other as long as they do not constitute a conflict with each other.

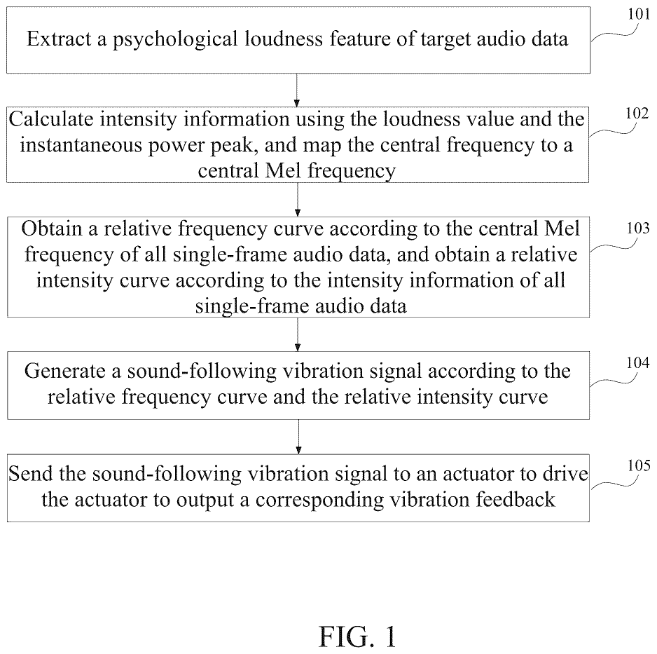

As shown in FIG. 1, which shows a flowchart of a sound-following vibration control method according to an embodiment of the present application, the sound-following vibration control method including steps 101 to 105 as follows.

Step 101, extracting a psychological loudness feature of the target audio data.

In the embodiment of the present application, if it is desired to generate a final sound-following vibration signal, it is necessary to first obtain target audio data of the audio and extract psychological loudness features from the obtained target audio data. The psychological loudness features include loudness values, instantaneous power peaks, center frequencies, and moments of single-frame audio data.

The psychological evaluation index in the embodiment of the present application is mainly embodied in the loudness value of the single-frame audio data. Generally, audio data has two main features, sound pressure value and frequency. However, according to psychoacoustics-related research, these two physical features do not directly map people's subjective auditory feelings, and loudness is the size of the sound intensity that people subjectively feel. Loudness is typically measured in units of phons or sones. Loudness generally increases with sound pressure level, but the relationship between the two is not linear. Additionally, the human ear's perception of loudness gradually diminishes as the sound pressure level increases. For sounds of different frequencies at the same sound pressure level, the human ear perceives their loudness differently. Typically, the ear is more sensitive to mid-to-high-frequency sounds and less sensitive to low-frequency sounds.

Therefore, in the embodiment, before the step of extracting the psychological loudness characteristics of the target audio data, it is also necessary to read in the raw audio data having the sound effect, and carry out a pre-processing for the audio, including using a corresponding filter to carry out a mid-frequency processing, so as to make the vibration generated corresponding to the sound effect more in line with the threshold of human tactile perception, and ultimately achieve a better vibration feedback effect. Prior to this, the pre-processing also includes downsampling the audio. Firstly, filtering is processed by a low-pass filter to remove high-frequency components in the signal to prevent aliasing from occurring during the downsampling process, and then the filtered signal is downsampled, thereby reducing the amount of data in the audio.

Step 102, calculating intensity information using the loudness value and the instantaneous power peak, and mapping the central frequency to the central Mel frequency.

In the embodiment of the present application, after obtaining the psychological loudness feature, it is necessary to convert the feature information into the parameters to be considered for specific vibration, i.e. vibration intensity and vibration frequency. Whereas the loudness value and the instantaneous power peak value in the characteristic information can characterize the intensity of the audio, thereby this embodiment sets corresponding weights to the loudness value and instantaneous power peak value, and then obtains the weighted value, i.e., the intensity information that can characterize the intensity of the vibration.

Similarly, the central frequency in the aforementioned feature information can represent the frequency characteristics of the vibration. However, based on the psychological studies mentioned above, an audio signal consists of a series of periodic vibrations with different frequencies. The human ear perceives sounds of different frequencies differently and can distinguish various pitches through frequency. However, the perception of frequency by the human ear is not linear but exhibits nonlinear characteristics.

Therefore, in the embodiments of the present application, to ensure consistency between auditory and tactile experiences, the central frequency is mapped to the central Mel frequency. In one embodiment of the present application, the Mel scale is introduced to convert the central frequency into the central Mel frequency. The Mel scale is a nonlinear frequency scale used to convert frequencies into Mel values. The conversion between the Mel scale and frequency may be achieved using a formula, and the Mel frequency refers to the frequency value obtained after conversion via the Mel scale. Compared to linear frequency, Mel frequency better aligns with the human ear's perception of sound. There are various methods to convert general linear frequencies into Mel frequencies that align with human auditory perception, including the use of Mel filter groups and Mel Frequency Cepstral Coefficients (MFCC), which is not limited in the present application. Those skilled in the art can flexibly adapt the settings based on the practical application scenarios within the scope of the embodiments of the present application.

Step 103: obtaining a relative frequency curve according to the central Mel frequency of all single frames of the audio data, and obtaining a relative intensity curve according to the intensity information of all single-frame audio data.

In the embodiment of the present application, after extracting the psychological loudness features of the audio data, it is also necessary to map the features to the vibration parameters of the actuator. Therefore, after obtaining the central Mel frequency of the single-frame audio data, it is also necessary to obtain the relative frequency curve according to the central Mel frequency, the horizontal axis of which is the number of frames, and the vertical axis of which is the relative frequency. Thus, the correspondence between the relative frequency and the number of frames is established, i.e., it characterizes the change in the frequency of the audio with the number of frames.

Specifically, a relative frequency interval of the actuator for generating vibration feedback is first obtained, and then a relative frequency curve is obtained by mapping the central Mel frequency of all single-frame audio data to the relative frequency interval according to a preset first nonlinear function. The first nonlinear function is a custom-constructed nonlinear function for realizing the conversion of audio frequencies into relative frequencies at which the actuator generates vibrations.

In an embodiment of the present application, it is also necessary to obtain a relative intensity curve according to the intensity information, the horizontal axis of which is the number of frames and the vertical axis of which is the relative intensity, so that a correspondence between the relative intensity and the number of frames is established.

Specifically, a relative intensity interval of an actuator for generating vibration feedback is first obtained, and then the intensity information of all the single frames of data is mapped into the relative intensity interval according to a preset second nonlinear function to obtain an initial relative intensity curve. Further, the initial relative intensity curve is optimized according to the human body's perceptible vibration intensity threshold to obtain a final relative intensity curve. The second nonlinear function is a custom-constructed nonlinear function for realizing the conversion of the audio intensity information into the relative intensity of vibration generated by the actuator.

Step 104: generating a sound-following vibration signal according to the relative frequency curve and the relative intensity curve.

Specifically, after obtaining the aforementioned relative frequency curve and the aforementioned relative intensity curve, it is possible to find the relative frequency corresponding to the frame moment on the relative frequency curve and the relative intensity corresponding to the frame moment on the relative intensity curve, and then integrate the relative intensity, the relative frequency, and the corresponding frame moment to generate the sound-following vibration signal.

In an embodiment of this embodiment, in order to expand the scope of application of the sound-following vibration signal, the final parameters can be written into a standard vibration file, and then the standard vibration file can be analyzed using a parsing tool to generate the corresponding sound-following vibration signal. The parameters of the parsing tool can be adjusted, so that the generated vibration feedback can be applied to different vibration devices and be applied to different scenarios.

Step 105: sending the sound-following vibration signal to the actuator to drive the actuator to output the corresponding vibration feedback.

In an embodiment of this embodiment, the above step of obtaining the relative frequency curve according to the central Mel frequency of all the single-frame audio data includes: obtaining a relative frequency interval of the actuator for generating the vibration feedback; and mapping the central Mel frequency of all single-frame audio data to the relative frequency interval according to a preset first nonlinear function to obtain the relative frequency curve. The above step of obtaining the relative intensity curve according to the intensity information of all single-frame audio data includes: obtaining a relative intensity interval of the actuator for generating the vibration feedback; and mapping the intensity information of all single-frame audio data to the relative intensity interval according to a preset second nonlinear function to obtain the relative intensity curve.

Specifically, in practical applications, the actuators configured to generate vibration feedback have different operating frequencies and operating intensities, and thus it is necessary to first obtain the relative frequency interval and the relative intensity interval of the actuators configured to generate vibration feedback, and map the central Mel frequency of the single-frame audio data to the relative frequency interval via the preset first nonlinear function to obtain the relative frequency curve, and map the intensity information into the relative intensity interval via the preset second nonlinear function to obtain the relative intensity curve. Further, the relative frequency curve and the relative intensity curve are utilized to characterize the features of the audio data, and the relative frequency curve and the relative intensity curve are utilized to generate the sound-following vibration signals in a subsequent step to complete the realization of the vibration with sound effects.

Further, in an implementation of this embodiment, the method further includes: mapping the relative intensity curve and the relative frequency curve to a vibration sensing curve according to a preset vibration sensing perception function; recording points in the vibration sensing curve below a lower limit value as first deletion points according to the lower limit value of human perceptible vibration intensity; and obtaining first corresponding moments of all the first deletion points, and deleting the points in the relative intensity curve and the relative frequency curve that are at the first corresponding moments to obtain an optimized relative intensity curve and an optimized relative frequency curve.

Specifically, in practical applications, the vibration feedback generated by some of the actuators is actually difficult to be sensed by the human body, and thus the vibration feedback can be optimized according to a lower limit value of the human body's perceptible vibration intensity. A fitted vibration sensing function is preset, the current relative intensity curve and relative frequency curve are mapped to the vibration sensing curve in accordance with f (intensity, frequency), and then the points in the vibration sensing curve that are lower than the lower limit value of the vibration intensity that can be perceived by the human body are recorded as deletion points, and correspondingly, the points in the relative intensity curve and the relative frequency curve at the corresponding frame moments are deleted, so as to obtain the optimized relative intensity curve and the relative frequency curve, and thus the optimized relative intensity curve and relative frequency curve are obtained, thereby optimizing the feedback mechanism for vibration with sound effects.

Further, in an implementation of this embodiment, the above step of mapping the relative intensity curve and the relative frequency curve into a vibration sensing curve according to the preset vibration sensing perception function includes: obtaining relative intensity information contained in the relative intensity curve; weighting the relative intensity information to obtain a weighted relative intensity curve; and mapping the relative frequency curve and the weighted relative intensity curve to a vibration sensing curve according to the preset vibration sensing perception function.

Specifically, Specifically, in practical applications, although the vibration feedback generated by some actuators can be perceived by the human body, it may not be prominent enough. Additionally, some different vibration feedbacks may not produce a significant distinction in human perception. Therefore, it is necessary to apply a certain weighting to the vibration intensity to increase the contrast in intensity, meaning that the original strong vibrations become stronger, and the original weak vibrations become weaker. In subsequent steps, vibrations below the threshold of human perceptible intensity are removed, ultimately improving the user's experience of the audio vibration feedback mechanism.

Further, in an implementation of this embodiment, the method further includes: verifying a target point in the vibration sensing curve for adjacent values, and recording the target point as a second deletion point when the target point in the vibration sensing curve meets a preset condition; obtaining second corresponding moments of all the second deleted points, and deleting points in the optimized relative intensity curve and the optimized relative frequency curve that are at the second corresponding moments to obtain a simplified relative intensity curve and a simplified relative frequency curve.

Specifically, in this embodiment, the long signal may be simplified in addition to optimizing the vibration effect. It should be understood that when the target point in the vibration sensing curve is subjected to adjacent value verifying, for any point in the vibration sensing curve, if the point together with its predecessor and successor points can jointly describe the local characteristics of the curve within a preset range, the point can be recorded as a deletion point, and the points corresponding to the deletion point in the optimized relative intensity curve and the optimized relative frequency curve can be omitted, so that the simplified processing of the long signal can be completed. The simplified processing of the long signal not only reduces the workload of the relevant designers but also ensures the continuity of the vibration experience.

In an implementation of this embodiment, the above step of generating the sound-following vibration signal according to the relative frequency curve and the relative intensity curve includes: generating an initial sound-following vibration signal according to the relative frequency curve and the relative intensity curve; and adding a short signal to the initial sound-following vibration signal according to a preset short signal parameter to obtain a final sound-following vibration signal. The short signal parameter includes an adding moment of the short signal, a frequency of the short signal, and an intensity of the short signal.

Specifically, in practical application, in order to further enrich the hierarchy of vibration intensity and optimize the human body's experience of the sound effect vibration feedback, the short signal may be added to the focus position of the sound effect to enhance the vibration feedback. The initial sound-following vibration signals are first generated according to the relative frequency curve and the relative intensity curve, and then according to the preset short signal parameter or the short signal parameter generated by the real-time audio signal, the short signal is added to the initial sound-following vibration signal to obtain the final sound-following vibration signal.

Further, in an implementation of this embodiment, the above method further includes: filtering peak points on the relative intensity curve to obtain a first peak point; fitting all the instantaneous power peaks to an instantaneous power peak curve, and obtaining a target point corresponding to the first peak point in the instantaneous power peak curve according to a preset filtering condition; and verifying a peak position of the first peak point with the target point to obtain the short signal parameter.

Further, in an implementation of this embodiment, the above step of filtering peak points on the relative intensity curve to obtain the first peak point includes: filtering peak points on the relative intensity curve to obtain an initial peak point; connecting all the initial peak points and performing a smoothing, to obtain a relative intensity envelope curve; and filtering peak points on the relative intensity envelope curve to obtain the first peak point.

Further, in an implementation of this embodiment, the above step of fitting all the instantaneous power peaks to the instantaneous power peak curve and obtaining the target point corresponding to the first peak point in the instantaneous power peak curve according to a preset filtering condition includes: obtaining all corresponding moments of the first peak value points and obtaining all corresponding time intervals by combining a preset minimum time difference; fitting all the instantaneous power peaks to the instantaneous power peak curve, and obtaining all points in the instantaneous power peak curve that are in the corresponding time interval; and recording all the points that are within the corresponding time interval as target points corresponding to the first peak point.

Specifically, in this embodiment, firstly, the relative intensity curve is filtered for peak points and the corresponding moments of peak points are obtained, then a minimum time difference is preset to obtain the corresponding time interval. Finally, the peak points of the relative intensity curve at the corresponding moments and the points within the corresponding time interval in the peak instantaneous power curve are verified for the peak position according to the preset method. If the point at the corresponding moment is judged to be the peak point, then the short signal is added at this point. Further, by adding the short signal at the focus position of the sound effect, thereby realizing an increase in the hierarchy of the vibration feedback effect.

Further, in an implementation of this embodiment, the above step of verifying the peak position of the first peak value point with the target point to obtain the short message number parameter, including: filtering peak points on the instantaneous power peak curve to obtain a second peak point; verifying whether the second peak point exists in the target point; when the second peak point exists in the target point, determining that the first peak point and the target point pass a peak position verification, and recording the first peak point that passes the peak position verification as a target first peak point; recording the corresponding moment of the target first peak value point as the adding moment of the short signal; obtaining a relative intensity corresponding to the adding moment of the short signal on the relative intensity curve, and increasing the relative intensity according to a preset relative intensity increase value to obtain the intensity of the short signal; and obtaining the short signal parameter according to all the adding moment of the short signals, the frequency of the short signal and the intensity of the short signal.

Specifically, in this embodiment, if the peak point at moment t also has a peak in a corresponding time interval of the instantaneous power peak curve, the short signal is added at the moment t, and the corresponding moment is recorded as the adding moment of the short signal number. Besides, the relative frequency corresponding to the adding moment of the short signal on the relative frequency curve is obtained to obtain the frequency of the short signal. The relative intensity corresponding to the adding moment of the short signal on the relative intensity curve is obtained to obtain the relative intensity, and the relative intensity is increased according to a preset relative intensity increase value to obtain the intensity of the short signal. Finally, the short signal parameters are obtained according to the adding moment of the short signal, the frequency of the short signal, and the intensity of the short signal.

As can be seen from the above, in the embodiments of the present application, psychological loudness characteristics are extracted from audio data, and loudness values, center frequencies, and power peaks are transformed into the relative intensity curve and relative frequency curve using psychological evaluation indexes combined with Mel weighting. A sound-following vibration signal is generated according to the relative intensity curve and relative frequency curve to maximize the retention of effective information mapped to actuator vibration parameters, and complete the vibration feedback control with sound effects, thereby effectively improving the richness of the human body's perception of vibration feedback, and bringing users an immersive sensory experience. In addition, this method enables the automatic generation of vibration feedback in a simple and efficient manner. On one hand, it meets the need for content providers to perform independent batch conversions. On the other hand, it requires only minimal optimization by designers to achieve high-quality vibration feedback, thereby further balancing the workload of design personnel.

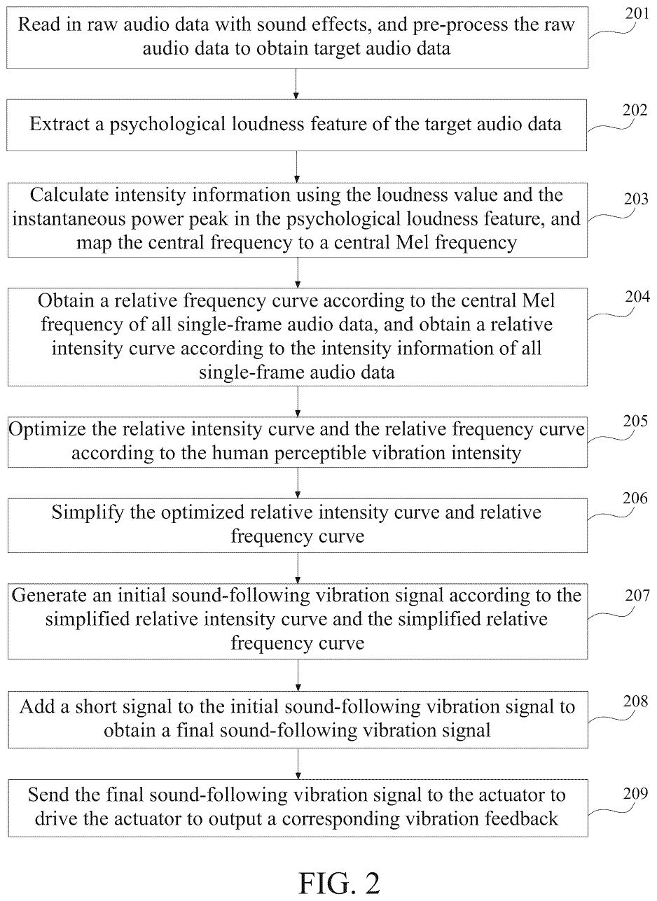

In summary, as shown in FIG. 2, an embodiment of the present application involve a refined flowchart of the sound-following vibration control method, which specifically as follows:
Step 201, reading in raw audio data with sound effects, and pre-processing the raw audio data to obtain target audio data;
Step 202, extracting a psychological loudness feature of the target audio data;
Step 203, calculating intensity information using the loudness value and the instantaneous power peak in the psychological loudness feature, and mapping the central frequency to a central Mel frequency;
Step 204, obtaining a relative frequency curve according to the central Mel frequency of all single-frame audio data, and obtaining a relative intensity curve according to the intensity information of all single-frame audio data;
Step 205, optimizing the relative intensity curve and the relative frequency curve according to the human perceptible vibration intensity;
Step 206, simplifying the optimized relative intensity curve and relative frequency curve;
Step 207, generating an initial sound-following vibration signal according to the simplified relative intensity curve and the simplified relative frequency curve;
Step 208, adding a short signal to the initial sound-following vibration signal to obtain a final sound-following vibration signal; and
Step 209, sending the final sound-following vibration signal to the actuator to drive the actuator to output a corresponding vibration feedback.

The more detailed flowchart of each step in steps 201 to 209 may be found in the description of the relevant portion shown in the preceding section, and the embodiments of the present application will not be repeated herein.

It should be understood that the size of the serial numbers of the steps in this embodiment does not imply the order of execution of the steps, and the order of execution of the steps should be determined by their functions and internal logic, and should not constitute a unique limitation on the implementation process of the embodiments of the present application.

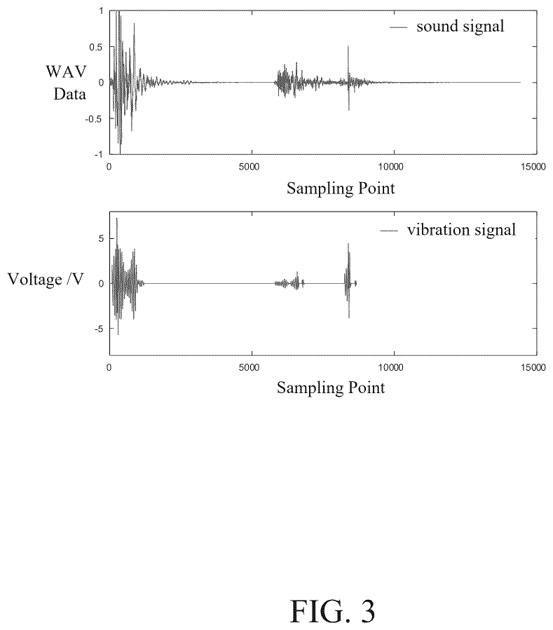

As shown in FIG. 3, FIG. 3 shows a schematic diagram of a vibration signal generated according to an original sound effect according to an embodiment of the present application. It can be clearly seen that the vibration signals obtained by the embodiments of the present application through the sound-following vibration control method can be mapped to the motor vibration parameters in a way that maximizes the retention of the effective information, thereby simplifying the processing of the long signals. Additionally, short signals are added to key points in the audio to enrich the layering of vibration intensity. This approach ensures the continuity of the vibrations while being designer-friendly, ultimately completing the conversion from audio to vibration.

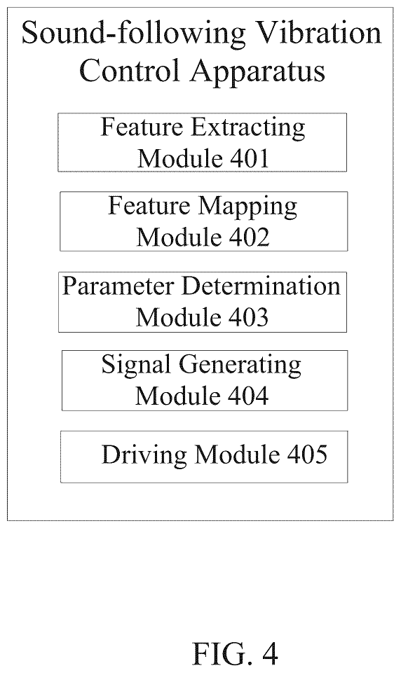

As shown in FIG. 4, FIG. 4 shows a schematic diagram of a program module of a sound-following vibration control apparatus according to an embodiment of the present application. The apparatus may be used to realize the sound-following vibration control method involved in the embodiments of the present application. The sound-following vibration control apparatus mainly includes:
a feature extracting module 401 configured to extract a psychological loudness feature of target audio data, wherein the psychological loudness feature includes a loudness value, an instantaneous power peak, a central frequency, and a moment of a single-frame audio data;
a feature mapping module 402 configured to calculate intensity information using the loudness value and the instantaneous power peak, and mapping the central frequency to a central Mel frequency;
a parameter determination module 403 configured to obtain a relative frequency curve according to the central Mel frequency of all single-frame audio data, and obtain a relative intensity curve according to the intensity information of all single-frame audio data;
a signal generating module 404 configured to generate a sound-following vibration signal according to the relative frequency curve and the relative intensity curve; and
a driving module 405 configured to send the sound-following vibration signal to an actuator to drive the actuator to output a corresponding vibration feedback.

In some implementations of this embodiment, the parameter determination module is specifically configured to: obtain a relative frequency interval of the actuator for generating the vibration feedback; map the central Mel frequency of all single-frame audio data to the relative frequency interval according to a preset first nonlinear function to obtain the relative frequency curve; obtain a relative intensity interval of the actuator for generating the vibration feedback; and map the intensity information of all single-frame audio data to the relative intensity interval according to a preset second nonlinear function to obtain the relative intensity curve.

Further, in some implementations of this embodiment, the parameter determination module is further configured to: map the relative intensity curve and the relative frequency curve to a vibration sensing curve according to a preset vibration sensing perception function; record points in the vibration sensing curve below a lower limit value as first deletion points according to the lower limit value of human perceptible vibration intensity; obtain first corresponding moments of all the first deletion points, and delete the points in the relative intensity curve and the relative frequency curve that are at the first corresponding moments to obtain an optimized relative intensity curve and an optimized relative frequency curve.

Further, in some implementations of this embodiment, the parameter determination module, in performing the function of mapping the relative intensity curve and the relative frequency curve to the vibration sensing curve according to the preset vibration sensing perception function, is specifically configured to: obtain relative intensity information contained in the relative intensity curve; weight the relative intensity information to obtain a weighted relative intensity curve; and map the relative frequency curve and the weighted relative intensity curve to a vibration sensing curve according to the preset vibration sensing perception function.

Further, in some implementations of this embodiment, the parameter determination module is further configured to: verify a target point in the vibration sensing curve for adjacent values, and record the target point as a second deletion point when the target point in the vibration sensing curve meets a preset condition; obtain second corresponding moments of all the second deleted points, and delete points in the optimized relative intensity curve and the optimized relative frequency curve that are at the second corresponding moments to obtain a simplified relative intensity curve and a simplified relative frequency curve.

In some implementations of this embodiment, the signal generating module is specifically configured to: generate an initial sound-following vibration signal according to the relative frequency curve and the relative intensity curve; and add a short signal to the initial sound-following vibration signal according to a preset short signal parameter to obtain a final sound-following vibration signal. The short signal parameter includes an adding moment of the short signal, a frequency of the short signal, and an intensity of the short signal.

Further, in some implementations of this embodiment, the signal generating module is further configured to: filter peak points on the relative intensity curve to obtain a first peak point; connect all the initial peak points and perform a smoothing to obtain a relative intensity envelope curve; filter peak points of the relative intensity envelope curve to obtain a second peak point; obtain the corresponding moments of all the second peak points, and obtain all corresponding time intervals by combining with a preset minimum time difference; fit all the instantaneous power peaks to the instantaneous power peak curve, and obtain all points in the instantaneous power peak curve that are in the corresponding time interval; verify the peak position of the second peak point with the points that are in the corresponding time intervals to obtain the short signal parameter.

Further, in some implementations of this embodiment, the signal generating module, in performing the function of verifying the peak position of the second peak point with the points that are in the corresponding time intervals to obtain the short signal parameter, is specifically configured to: filter the peak points of the instantaneous power peak curve to obtain a third peak point; record third corresponding moment as an adding moment of the short signal when the third corresponding moment of the third peak point is within the corresponding time interval; obtain a relative frequency corresponding to the adding moment of the short signal on the relative frequency curve to obtain the frequency of the short signal; obtain a relative intensity corresponding to the adding moment of the short signal on the relative intensity curve, and increase the relative intensity according to a preset relative intensity increase value to obtain the intensity of the short signal; and obtain the short signal parameter according to all the adding moment of the short signals, the frequency of the short signal and the intensity of the short signal.

In an implementation of this embodiment, the sound effect vibration control device further includes: a pre-processing module, which is configured to read in raw audio data having a sound effect, and pre-process the raw audio data to obtain the target audio data.

According to the sound-following vibration control apparatus provided in this embodiment, a psychological loudness feature is extracted from the target audio data and intensity information is calculated using the loudness values and the instantaneous power peaks in the psychological loudness feature, and the central frequency is mapped to a central Mel frequency. Secondly, a relative frequency curve is obtained according to the central Mel frequency of all single-frame audio data, and a relative intensity curve is obtained according to the intensity information of all single-frame audio data. Finally, a sound-following vibration signal is generated according to the relative frequency curve and the relative intensity curve, and the sound-following vibration signal is sent to an actuator to drive the actuator to output a corresponding vibration feedback. Through the implementation of the solutions of the present application, psychological loudness characteristics are extracted from audio data, and loudness values, center frequencies, and power peaks are transformed into the relative intensity curve and relative frequency curve using psychological evaluation indexes combined with Mel weighting. A sound-following vibration signal is generated according to the relative intensity curve and relative frequency curve to maximize the retention of effective information mapped to actuator vibration parameters, and complete the vibration feedback control with sound effects, thereby effectively improving the richness of the human body's perception of vibration feedback, and bringing users an immersive sensory experience. In addition, this method enables the automatic generation of vibration feedback in a simple and efficient manner. On one hand, it meets the need for content providers to perform independent batch conversions. On the other hand, it requires only minimal optimization by designers to achieve high-quality vibration feedback, thereby further balancing the workload of design personnel.

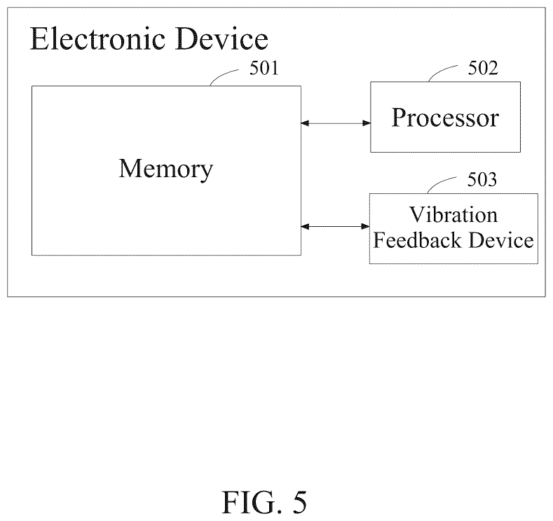

As shown in FIG. 5, FIG. 5 is a block diagram of modules of an electronic device according to an embodiment of the present application.

As shown in FIG. 5, the embodiment of the present application also provides an electronic device that can be used to implement the sound-following vibration control method in the preceding embodiments, including a memory 501 and at least one processor 502. The memory 501 is configured to store at least one program, and when the at least one program is executed by the at least one processor 502, the at least one processor 502 is caused to execute the sound-following vibration control method provided by embodiments of the present application.

Further, the electronic device further includes a vibration feedback device 503, which is configured to synchronize the vibration according to the sound-following vibration signal output by the processor 502 to achieve a corresponding vibration effect.

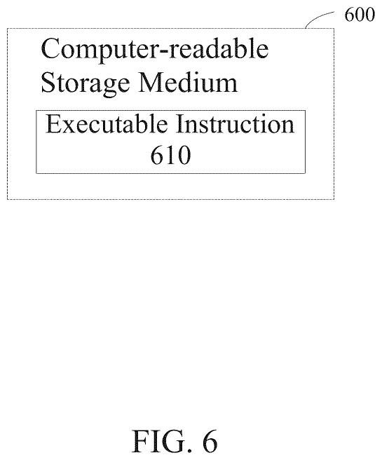

As shown in FIG. 6, FIG. 6 shows a block diagram of modules of a computer-readable storage medium according to an embodiment of the present application.

As shown in FIG. 6, the embodiment of the present application also provides a computer-readable storage medium 600 having an executable instruction 610 stored thereon. The executable instruction 610 when executed executes the sound-following vibration control method provided by the embodiments of the present application.

The steps of the method or algorithm described in conjunction with the embodiments disclosed herein may be implemented directly with hardware, a software module executed by a processor, or a combination of both. The software module may be placed in random access memory (RAM), read-only memory (ROM), electrically programmable ROM, electrically erasable programmable ROM, registers, hard disks, removable disks, CD-ROMs, or any other form of storage medium known in the art.

In the above embodiments, this may be accomplished in whole or in part by software, hardware, firmware, or any combination thereof. When implemented using software, it may be implemented in whole or in part in the form of a computer program product. The loading and execution of the computer program instructions on a computer may produce, in whole or in part, a process or function in accordance with the present application. The computer may be a general-purpose computer, a specialized computer, a computer network, or other programmable device. The computer instructions may be stored in a computer-readable storage medium or transmitted from one computer-readable storage medium to another computer-readable storage medium, e.g., the computer instructions may be transmitted by wired (e.g., coaxial cable, fiber optic, digital subscriber line) or wireless (e.g., infrared, wireless, microwave, etc.) means from one website site, computer, server, or data center to another website site, computer, server, or data center for transmission. The computer-readable storage medium may be any usable medium that a computer can access or a data storage device such as a server, or data center that contains one or more usable media integrated. The usable medium may be a magnetic medium, (e.g., floppy disk, hard disk, tape), an optical medium (e.g., DVD), or a semiconductor medium (e.g., a solid-state drive Solid State Disk), and the like.

It should be noted that each embodiment in the contents of the present application is described in a progressive manner, and each embodiment focuses on the differences with other embodiments, and the same and similar portions of each embodiment may be referred to each other. For the product class embodiments, due to its similarity to the method class embodiments, so the description is relatively simple, relevant to see the method class embodiments can be part of the description.

It should also be noted that in the present application, relationship terms such as first and second are used only to distinguish one entity or operation from another, and do not necessarily require or imply that any such actual relationship or order exists between these entities or operations. Furthermore, the terms “include”, “comprise”, or any other variant thereof, are intended to cover non-exclusive inclusion, such that a process, method, article, or equipment including a set of elements includes not only those elements, but also other elements not expressly listed, or elements inherent to such process, method, article or equipment. Or it may also include elements that are inherent to such process, method, article, or equipment. Without further limitation, the fact that an element is defined by the phrase “including a . . . ” does not preclude the existence of another identical element in the process, method, article, or apparatus that includes the element.

The above description of the disclosed embodiments enables a person skilled in the art to realize or use the contents of the present application. Various modifications to these embodiments will be apparent to those skilled in the art, and the general principles defined in the contents of this application can be realized in other embodiments without departing from the spirit or scope of the contents of the present application. Therefore, the present application contents will not be limited to these embodiments shown in the contents of the present application, but will be subject to the widest scope consistent with the principles and novel features disclosed in the contents of the present application.

What is claimed is:

1. A sound-following vibration control method, comprising:
extracting a psychological loudness feature of target audio data, wherein the psychological loudness feature comprises a loudness value, an instantaneous power peak, a central frequency, and a moment of a single-frame audio data;
calculating intensity information using the loudness value and the instantaneous power peak, and mapping the central frequency to a central Mel frequency;
obtaining a relative frequency curve according to the central Mel frequency of all single-frame audio data, and obtaining a relative intensity curve according to the intensity information of all single-frame audio data;
generating a sound-following vibration signal according to the relative frequency curve and the relative intensity curve; and
sending the sound-following vibration signal to an actuator to drive the actuator to output a corresponding vibration feedback.

2. The sound-following vibration control method of claim 1, wherein before the step of extracting the psychological loudness feature of target audio data, the method further comprises:
reading in raw audio data having a sound effect;
pre-processing the raw audio data to obtain the target audio data, wherein the pre-processing comprises at least one of the following: filtering processing and downsampling processing.

3. The sound-following vibration control method of claim 1, wherein the step of obtaining the relative frequency curve according to the central Mel frequency of all single-frame audio data comprises:
obtaining a relative frequency interval of the actuator for generating the vibration feedback; and
mapping the central Mel frequency of all single-frame audio data to the relative frequency interval according to a preset first nonlinear function to obtain the relative frequency curve;
the step of obtaining the relative intensity curve according to the intensity information of all single-frame audio data comprises:
obtaining a relative intensity interval of the actuator for generating the vibration feedback; and
mapping the intensity information of all single-frame audio data to the relative intensity interval according to a preset second nonlinear function to obtain the relative intensity curve.

4. The sound-following vibration control method of claim 3, further comprising:
mapping the relative intensity curve and the relative frequency curve to a vibration sensing curve according to a preset vibration sensing perception function;
recording points in the vibration sensing curve below a lower limit value as first deletion points according to the lower limit value of human perceptible vibration intensity; and
obtaining first corresponding moments of all the first deletion points, and deleting the points in the relative intensity curve and the relative frequency curve that are at the first corresponding moments to obtain an optimized relative intensity curve and an optimized relative frequency curve.

5. The sound-following vibration control method of claim 4, wherein the step of mapping the relative intensity curve and the relative frequency curve to the vibration sensing curve according to the preset vibration sensing perception function comprises:
obtaining relative intensity information contained in the relative intensity curve;
weighting the relative intensity information to obtain a weighted relative intensity curve; and
mapping the relative frequency curve and the weighted relative intensity curve to a vibration sensing curve according to the preset vibration sensing perception function.

6. The sound-following vibration control method of claim 4, further comprising:
verifying a target point in the vibration sensing curve for adjacent values, and recording the target point as a second deletion point when the target point in the vibration sensing curve meets a preset condition;
obtaining second corresponding moments of all the second deleted points, and deleting points in the optimized relative intensity curve and the optimized relative frequency curve that are at the second corresponding moments to obtain a simplified relative intensity curve and a simplified relative frequency curve.

7. The sound-following vibration control method of claim 1, wherein the step of generating the sound-following vibration signal according to the relative frequency curve and the relative intensity curve comprises:
generating an initial sound-following vibration signal according to the relative frequency curve and the relative intensity curve; and
adding a short signal to the initial sound-following vibration signal according to a preset short signal parameter to obtain a final sound-following vibration signal; wherein the short signal parameter comprises an adding moment of the short signal, a frequency of the short signal, and an intensity of the short signal.

8. The sound-following vibration control method of claim 7, further comprising:
filtering peak points on the relative intensity curve to obtain a first peak point;
fitting all the instantaneous power peaks to an instantaneous power peak curve, and obtaining a target point corresponding to the first peak point in the instantaneous power peak curve according to a preset filtering condition; and
verifying a peak position of the first peak point with the target point to obtain the short signal parameter.

9. The sound-following vibration control method of claim 8, wherein the step of filtering peak points on the relative intensity curve to obtain the first peak point comprises:
filtering peak points on the relative intensity curve to obtain an initial peak point;
connecting all the initial peak points and performing a smoothing, to obtain a relative intensity envelope curve; and
filtering peak points on the relative intensity envelope curve to obtain the first peak point.

10. The sound-following vibration control method of claim 8, wherein the step of fitting all the instantaneous power peaks to the instantaneous power peak curve and obtaining the target point corresponding to the first peak point in the instantaneous power peak curve according to a preset filtering condition comprises:
obtaining all corresponding moments of the first peak value points and obtaining all corresponding time intervals by combining a preset minimum time difference;
fitting all the instantaneous power peaks to the instantaneous power peak curve, and obtaining all points in the instantaneous power peak curve that are in the corresponding time interval; and
recording all the points that are within the corresponding time interval as target points corresponding to the first peak point.

11. The sound-following vibration control method of claim 10, wherein the step of verifying the peak position of the first peak point with the target point to obtain the short signal parameter comprises:
filtering peak points on the instantaneous power peak curve to obtain a second peak point;
verifying whether the second peak point exists in the target point;
when the second peak point exists in the target point, determining that the first peak point and the target point pass a peak position verification, and recording the first peak point that passes the peak position verification as a target first peak point;
recording the corresponding moment of the target first peak value point as the adding moment of the short signal;
obtaining a relative frequency corresponding to the adding moment of the short signal on the relative frequency curve to obtain the frequency of the short signal;
obtaining a relative intensity corresponding to the adding moment of the short signal on the relative intensity curve, and increasing the relative intensity according to a preset relative intensity increase value to obtain the intensity of the short signal; and
obtaining the short signal parameter according to all the adding moment of the short signals, the frequency of the short signal, and the intensity of the short signal.

12. An electronic device, comprising:
a memory; and
a processor configured to execute a computer program stored in the memory;
wherein the processor, when executing the computer program, realizes the steps in the sound-following vibration control method of claim 1.

13. A computer-readable storage medium having a computer program stored thereon, wherein the computer program, when executed by the processor, realizes the steps in the sound-following vibration control method of claim 1.
